(19) United States
(12) Patent Application Publication
(10) Pub. No.: US 2012/0240546 A1
(43) Pub. Date: Sep. 27, 2012

(54) Tractor Implement Combination

(76) Inventor: Georg Kormann, Zweibrucken (DE)

(21) Appl. No.: 13/514,136

(22) PCT Filed: Dec. 3, 2010
(86) PCT No.: PCT/EP10/68814

§ 371 Date: Jun. 6, 2012

(30) Foreign Application Priority Data
Dec. 7, 2009 (DE) 10 2009 047 585.0

(51) Int. Cl. B62D 6/00; A01D 87/00

(52) U.S. Cl. 56/344; 701/41; 701/23

(57) ABSTRACT

Provided is a combination of a tractor and a implement drawn by the tractor by way of a draw bar, supported on the ground by wheels, the implement having a processing element interacting with a field. A controller is connected to a first actuator disposed for adjusting the angle between the draw bar and the implement, and to a second actuator disposed for adjusting the angle of the wheels of the implement about the vertical axis. The controller can be operated for actuating the two actuators in such a manner that the longitudinal axis of the processing element is always oriented at least nearly orthogonal to a target line.

### FIELD OF THE DISCLOSURE

The disclosure concerns a combination of a tractor and a implement that is drawn by the tractor by way of a draw bar, and supported on the ground by wheels and that comprises a processing element interacting with a field, with a control device that is connected to an actuator, with which the implement can be steered in a lateral direction relative to the tractor.

### BACKGROUND OF THE DISCLOSURE

In agricultural applications, there are frequently cases in which pulled implements are drawn behind tractors and the intention is to move the implements on a desired theoretical path, so as to, for example, remove harvested crops from a field or bring out materials onto a field. In the past, to this end, the tractor was steered and the implement suspended by way of a draw bar on a coupling of the tractor followed the tractor, wherein the theoretical path of the implement could not always be maintained exactly because of the different movement paths of the tractor and the implement.

In order to simplify in a baler, the preparation of a bale uniform over the width of the bale formation chamber, the proposal in U.S. Pat. No. 4,433,533, regarded as generic, was to detect the size of the bale over the width of the round bale, and as a function of the individual form of the bale, either to move the baler in a lateral direction relative to the tractor by way of a hydraulic cylinder or to swivel the wheels of the baler around the vertical axis. In this way, the tractor is moved along the windrow by the operator, while the baler automatically moves on a curve-like or meandering path and a cylindrical bale is produced.

Furthermore, EP 1 634 491 A1 describes a baler with sensors for the detection of the bale size and distributed over the width of the bale-forming chamber. The sensors are connected to the control, which controls an automatic steering direction of the tractor in such a manner that the tractor is conducted automatically along the windrow and, dependent on the individual shape of the bale, moves more or less far laterally next to the windrow so as to produce a cylindrical bale.

EP 1 685 759 A1 describes another baler in which the tractor is conducted automatically along the windrow and sensors distributed over the width of the bale-forming chamber for the detection of the bale size are connected to a control, which controls the automatic steering direction of the tractor, or an actuator, which adjusts the draw bar of the baler so as to produce bales that are homogeneous over the width.

The known embodiments in which the tractor is steered so as to make it possible for the implement to be moved along the desired theoretical path have the disadvantage that the driver of the tractor is also exposed to the lateral movements, which over time can be tiring and uncomfortable. Moreover, there is the danger with a baler, for example, that the wheels of the tractor move over the draw bar and compress and soil it in an undesired manner. With embodiments in which the implement is forced-steered relative to the tractor, there are occasionally, on the other hand, operating situations in which a processing element of the implement—for example, with a baler or a trailer, a crop collector—is not oriented in an orthogonal manner relative to the windrow, that is, it is moved in a lateral direction relative to the windrow, which can lead to undesired distortions and wear phenomena in the tines of the crop collector.

### SUMMARY OF THE DISCLOSURE

The goal of the disclosure is to be found in making available a combination of a tractor and a drawn implement, in which a lateral movement of the processing element of the implement relative to a theoretical line will not be expected or will occur to a reduced extent.

A combination is composed of a tractor and a implement drawn by a tractor. The implement is drawn by a tractor by way of a draw bar; it is supported on the ground by wheels and comprises a processing element that interacts with a field, for example, a crop collector or a sprayer boom. Furthermore, a control device is connected, which is found on board the tractor or the implement or can be adjusted spatially over both. The control device is connected to a first actuator, which is used to adjust the angle between the draw bar and the implement. The first actuator can (for the direct adjustment of the draw bar relative to the implement) be located between the draw bar and a carriage of the implement or (for the indirect adjustment of the draw bar relative to the implement) between the tractor and the draw bar. Furthermore, the control device is coupled to a second actuator, which is used to steer the wheels—that is, to adjust their angle around the vertical axis. During operation, the control device controls the two actuators in a way so that the longitudinal axis of the processing element is always oriented at least approximately orthogonal to a theoretical line.

In this way, it is possible for the processing element to always be oriented transverse to the theoretical line, which reduces the wear with a processing element interacting with a windrow.

With a preferred embodiment of the disclosure, the implement is a collecting vehicle for the crops, for example, a baler for rectangular or round bales or a trailer. As a processing element, a crop collector is provided, which is used to take up a windrow from the ground. The collecting vehicle also has a container to hold the collected crops, in particular, in the form of a baling chamber or a loading container. In order to obtain a uniform distribution of the crop in the container and thus uniform bales, sensors are distributed over the width of the container; they detect the lateral distribution of the crop. The sensors are connected to the control device. The signals of the sensors serve the control device (in addition to the orientation of the processing element transverse to the theoretical line, which corresponds to the longitudinal axis of the windrow in this embodiment) as a second parameter to control the actuators. The container is correspondingly filled up according to a filling strategy.

The control device can be acted on by a position determining device and/or a detection device with information regarding the location of the theoretical line.

The tractor can be conducted along the theoretical line by an operator or based on signals of a position-determining device and/or the detection device (particularly those mentioned previously).

### BRIEF DESCRIPTION OF THE DRAWINGS

Embodiments of the disclosure are described in detail below with reference to the accompanying drawings wherein:

FIG. 1 is a side view of a tractor with a drawn implement;

FIG. 2 is a top view of the tractor and the implement; and

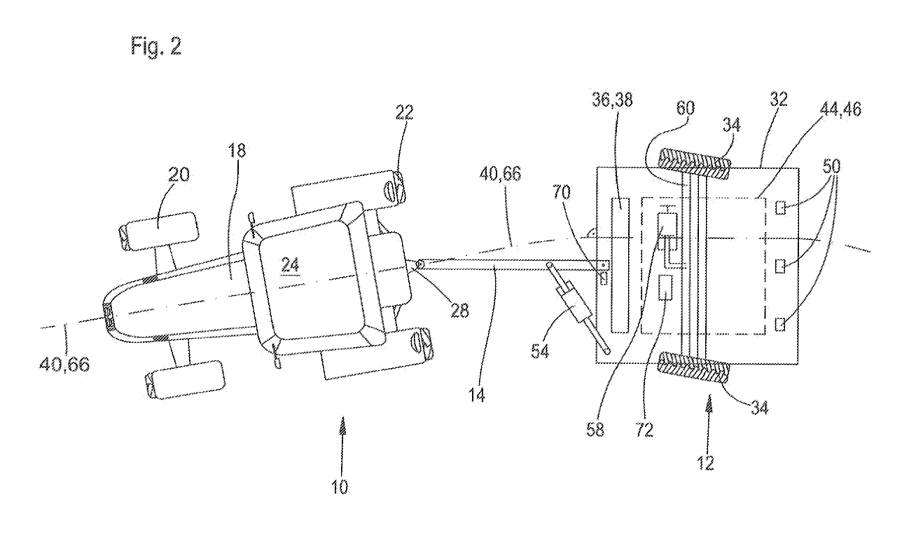

FIG. 3 is a flow chart according to which the control device of the implement works.

### DESCRIPTION OF THE PREFERRED EMBODIMENT

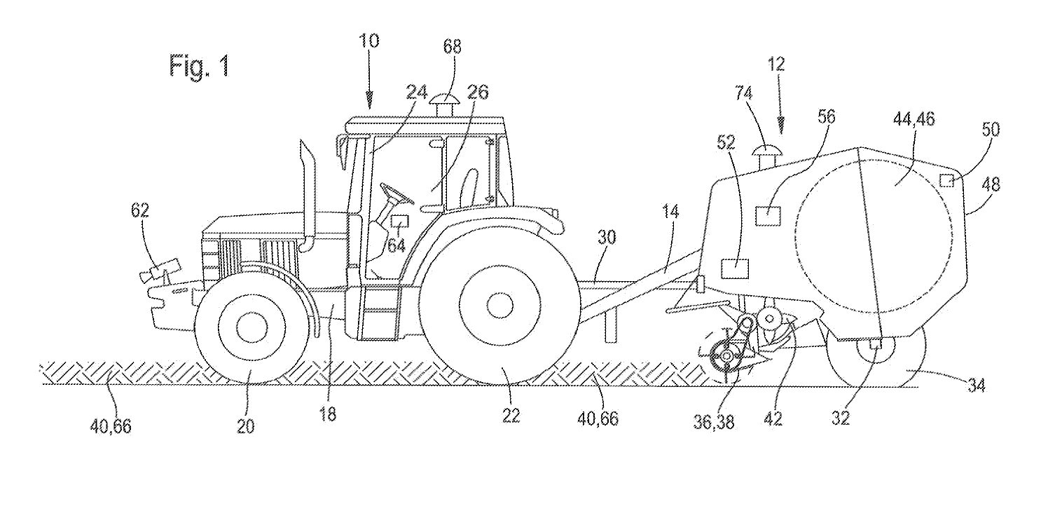

FIG. 1 shows a side view of an agricultural tractor 10 in the form of a tractor and a implement 12, coupled by way of a draw bar 14 to a suspension coupling 28 of the tractor 10, in the form of a round baler with a variable size baling chamber. The tractor 10 is built on a frame 18, which is supported on steerable front wheels 20 and drivable rear wheels 22 and carries a cab in which there is a work station for the operator 26.

The implement 12 comprises a carriage 32 that is supported on the ground via steerable wheels 34, a processing element 36 in the form of a crop collector 38 to collect crops lying on the ground in a windrow 40, and a conveyer 42 that conveys the crops taken up by the crop collector 38 into a container 46 in the form of a baling chamber 44. The baling chamber 44 is limited in a manner that is in fact known by baling elements (not depicted) in the form of belts. A completed bale can be ejected through a back door that can pivot upwards, and deposited on the field. The mechanical drive of the driven elements of the implement 12 is carried out by the tractor 10 via a universal joint shaft 30, although a drive with electric motors would also be conceivable, which are supplied with electrical energy by the tractor 10.

In total, three sensors 50 are distributed over the width of the container 46; they are used to detect the diameter of the bale and/or to detect the tension of the baling elements, which likewise contain information on the distribution of the crops over the width of the container 46. The sensors 50 are connected to a control device 52, which is located on board the implement 12, but which could also be located on board the tractor 10. The control device 52 is connected via a valve arrangement 56 to a first actuator 54 in the form of a hydraulic cylinder, which is articulated on one end on the draw bar 14 and on the other end on the carriage 32. The control device is connected, moreover, via the valve arrangement 56 to a second actuator 58 in the form of a hydraulic cylinder, which is coupled to a rod 60 to swivel the wheels 34 of the implement 12 around the vertical axis. By way of feedback sensors 70, 72, the control implement 52 gives information regarding the actual angles of the draw bar 14 and the wheels 34.

A detection device 62 in the form of a camera is placed on the front side of the tractor 10; it detects the windrow 40 optically and is connected to an image processing system, which emits a steering signal to a steering control 64 of the tractor, which in turn adjusts the steerable front wheels 20 of the tractor via a suitable actuator (not depicted) in such a manner that the longitudinal middle axis of the tractor 10 is conducted at least approximately on a theoretical line 66, which corresponds to the longitudinal axis of the windrow 40. In another embodiment, data regarding the position of the windrow are stored in the steering control 64 and a position-determining device 68 (for example, in the form of a GPS antenna) transmits to the steering control 64 up-to-date position information, which is used together with the stored data regarding the position of the windrow by the steering control 64 to control the actuator for the steerable front wheels 20. Both variants mentioned in this paragraph can also be combined (see EP 1 266 553 A2). The steering control 64 continuously transmits to the control device 52 data regarding the lateral position of the theoretical line 66 relative to the longitudinal middle axis of the tractor 10 and the corresponding time of the detection and/or the corresponding position in the forward direction, and is, to this end, connected to the control device 52 via a bus.

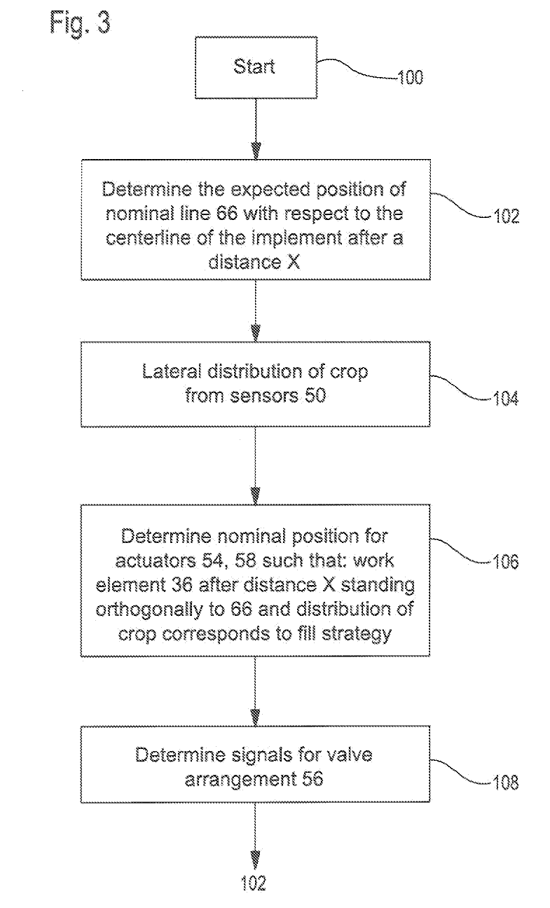

In the light of the foregoing, the mode of operation of the control device 52 shown in FIG. 3 is produced. After the start in step 100, step 102 follows, in which the expected position of the theoretical line 66 relative to the middle line of the implement 12 after traversing a stretch of the length x (of, for example, 1 m) is determined on the processing element 36. Thus, the expected lateral offset of the windrow 40 relative to the longitudinal middle plane of the implement 12 is determined on a site lying approximately the distance x in front of the implement 12. This position can be determined with the aid of the signals by the steering control 64 and the distance traversed until the attaining of the elapsed time or the distance traversed from the implement 12 (between the detection by the detection device 62 and the reaching of the site). The lateral movement of the implement can be derived from the signals of the feedback sensors 70, 72 and/or another feedback sensor (not depicted) located between the draw bar 14 and the coupling 28, and/or an individual position-determining device 74 is allocated to the implement 12, or for the purpose, a kinematic model (see WO 2008/005159 A2) is used for the combination of the tractor 10 and the implement 12.

In the following step 104, the lateral distribution of the crops in the container 46 is detected by the sensors 50. Then step 106 follows, in which the theoretical positions for the actuators 54 and 58 are calculated. They are determined in such a way that, on the one hand, the processing element 36 is still orthogonal to the theoretical line 66 even after the traversing of the distance x; on the other hand, however, the distribution of the crops in the container corresponds to the filling strategy, which can, for example, imply that first the left half of the bale is built up to a diameter of 10% of the desired bale size, then the right half is built up to a diameter of 20% of the desired bale size, then, in turn, the left half of the bale is built up to a diameter of 30%, etc. In this respect, one can additionally refer to the state of the art according to EP 1 634 491 A1 and EP 1 813 146 A2, whose disclosures are incorporated in the documentation under consideration by reference.

In step 106, then, signals for the valve arrangement 56 are determined and transmitted, which are based on the result of step 104 and the initial values of the sensors 70, 72 with regard to the up-to-date positions of the actuators 54 and 58. Step 102 follows, in turn.

It should be noted that other refinements would also be possible. Thus, the tractor 10 and/or the implement 12 could be equipped with an inclination sensor (not depicted) for the detection of the side inclination of the ground, whose signals are supplied to the control device 52. The control device 52 can then steer the implement 12 upwards on the slope, so as to compensate for slippage. The signals of the inclination sensor can also be used in order to place the implement 12 parallel to the slope before automatically ejecting a bale and thus preventing it from rolling down the slope.

Having described the preferred embodiment, it will become apparent that various modifications can be made without departing from the scope of the invention as defined in the accompanying claims.

The invention claimed is:

1. A combination of a tractor and a implement, which is drawn by the tractor by way of a draw bar, and supported on the ground by wheels, which comprises a processing element interacting with a field with a control device, which is connected to an actuator with which the implement is steerable in a lateral direction relative to the tractor, wherein the control device is connected to a first actuator, which is set up to adjust the angle between the draw bar and the implement, wherein the control device is connected to a second actuator, which is set up to adjust the angle of the wheels of the implement around the vertical axis, and wherein the control device can be operated to control the two actuators in such a manner that the longitudinal axis of the processing element is always, at least approximately, orthogonal to a theoretical line.

2. A combination according to claim 1, wherein the implement is a collecting vehicle for crops, which comprises as a processing element a crop collector to take up crops from a windrow, a container to hold the collected crops, and sensors to detect the lateral distribution of crops in the container, wherein the control device is connected to and can be operated with the sensors to control the two actuators in such a manner that the container is filled in accordance with a filling strategy and the theoretical line corresponds to the longitudinal axis of the windrow.

3. A combination according to claim 1, wherein the control device is acted on by at least one of a position-determining device and a detection device with information regarding the position of the theoretical line.

4. A combination according to claim 3, wherein the control device is operated to compensate for at least one of the time and local offset of the detection of the position of the theoretical line and the reaching of the pertinent site by the processing element with the aid of at least one of: signals from the feedback sensors to detect the position of at least one of the draw bar and the wheels; signals of a position-determining device allocated to the tractor; signals of a position-determining device allocated to the implement; and with the aid of a kinematic model of the combination of the tractor and the implement.

5. A combination according to one of claim 1, wherein the tractor is steered one of manually and automatically along the theoretical line.

6. A combination according to claim 5, wherein the tractor is equipped with a steering control, which is connected to the control device and at least one of the position-determining device and the detection device to detect the position of the theoretical line.
